(19) United States
(12) Patent Application Publication
(10) Pub. No.: US 2005/0154794 A1
(43) Pub. Date: Jul. 14, 2005

(54) Systems and methods for providing a discovery protocol

(76) Inventor: Sachin Govind Deshpande, Vancouver, WA (US)

Correspondence Address: Michael F. Krieger;Kirton & McConkie, 1800 Eagle Gate Tower, 60 East South Temple, Salt Lake City, UT, 84111, US

(21) Appl. No.: 10/757,102

(22) Filed: Jan. 14, 2004

(51) Int. Cl. G06F 15/16

(52) U.S. Cl. 709/227; 709/203

(57) ABSTRACT

Systems and methods for providing and utilizing a discovery protocol that allows a computer device and a television (TV) to discover each other on a network. A combination of a User Datagram Protocol (UDP) broadcast request and a unicast reply transaction is employed for implementing the discovery procedure. Support is provided for versioning to allow the TV to only accept and make connections to the correct version of a home personal computer. Further, responses can be handled from multiple computer devices.

### BACKGROUND OF THE INVENTION

1. Field of the Invention

The present invention relates to discovery protocols. In particular, the present invention relates to systems and methods for providing and utilizing a discovery protocol that allows a computer device and a television to discover each other on a network.

2. Background and Related Art

A variety of discovery protocol techniques are currently available. Examples of such techniques include the Salutation protocol, the service location protocol (SLP), the JINI protocol, the Universal Plug and Play (UPnP) protocol, and the Simple Service Discovery Protocol (SSDP). The salutation protocol defines an abstract model with three components: Client, Server, and Salutation Manager (SLM). The salutation defines its protocol based on SunRPC. The Service Location Protocol (SLP) defines an abstract architecture that includes “User Agents” (UA) (clients), “Service Agents” (SA) (services) and “Directory Agents” (DA) (directories). The JINI protocol is largely defined as exchanges of serialized Java objects, mostly via Java Remote Method Invocation (RMI). UPnP is a Microsoft standard for spontaneous configuration. The Universal Plug and Play (UPNP) includes a Simple Service Discovery Protocol (SSDP), which may be used to discover devices and services.

While discovery protocol techniques currently exist, ongoing efforts are being made to improve the discovery protocols since challenges still exist. For example, many of the existing protocols are heavyweight protocols. Accordingly, it would be an improvement in the art to augment or even replace current techniques with other techniques.

### SUMMARY OF THE INVENTION

The present invention relates to discovery protocols. In particular, the present invention relates to systems and methods for providing and utilizing a discovery protocol that allows a computer device and a television to discover each other on a network.

Implementation of the present invention takes place in association with methods and processes that allow a computer device and a television to discover each other on a network. For example, in one implementation, a home personal computer device is able to discover a television (TV) and/or the TV is able to discover the home personal computer device on a network, such as a home network. The methods and processes for discovery are lightweight and provide support for versioning.

In one implementation, a combination of a User Datagram Protocol (UDP) broadcast request and a unicast reply transaction is employed for the discovery. Support is provided for versioning, which allows the TV to only accept and make connections to a correct version of a server. Further, responses can be handled from multiple computer devices.

Thus, while the methods and processes of the present invention have proven to be particularly useful in association with TV, those skilled in the art will appreciate that the methods and processes can be used in a variety of different applications relating to utilizing a discovery protocol corresponding to television.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 illustrates a representative networked system configuration in accordance with an embodiment of the present invention; and

FIG. 3 is a flow chart that illustrates representative processing in accordance with an embodiment of the present invention.

### DETAILED DESCRIPTION OF THE INVENTION

The present invention relates to discovery protocols. In particular, the present invention relates to systems and methods for providing and utilizing a discovery protocol that allows a computer device and a television to discover each other on a network.

Embodiments of the present invention take place in association with methods and processes that allow a computer device and a television to discover each other on a network. For example, in one embodiment, a home personal computer device is able to discover a television (TV) and/or the TV is able to discover the home personal computer device on a network, such as a home network. The methods and processes for discovery are lightweight and provide support for versioning.

In one embodiment, a combination of a User Datagram Protocol (UDP) broadcast request and a unicast reply transaction is employed for the discovery. Support is provided for versioning, which allows the TV to only discover and make connections to a correct version of a server. Further, responses can be handled from multiple computer devices.

The following disclosure of the present invention is grouped into two subheadings, namely “Exemplary Operating Environment” and “Providing a Discovery Protocol.” The utilization of the subheadings is for convenience of the reader only and is not to be construed as limiting in any sense.

### Exemplary Operating Environment

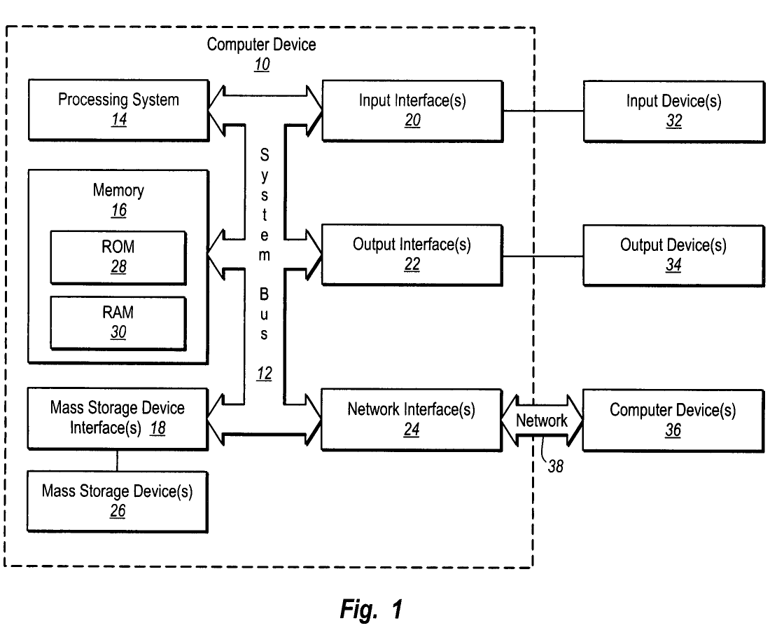

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, a television, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

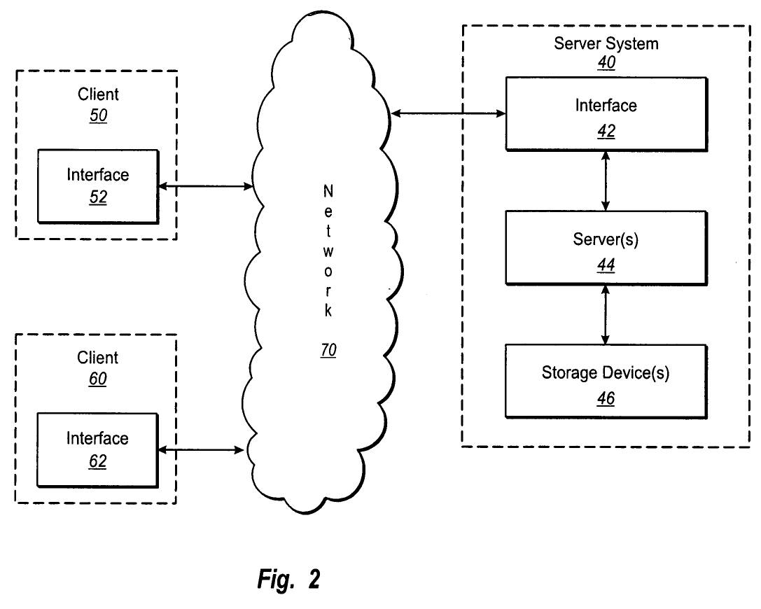

While those skilled in the art will appreciate that the invention may be practiced in networked computing environments with many types of system configurations, FIG. 2 represents an embodiment of the present invention that enables a client (e.g., a camera) to discover or be otherwise discovered on the network. In the illustrated embodiment, the term “client” is being used to reference a TV or other device and the term “server” to reference a computer device, such as a home personal computer or other device. While FIG. 2 illustrates an embodiment that includes two clients connected to the network, alternative embodiments include one client connected to a network, or multiple clients connected to a network. In some embodiments, the network is a home network. In other embodiments, the network is a wireless network. In some embodiments multiple are servers connected to the network.

In FIG. 2, server system 40 represents a system configuration that includes an interface 42, one or more computer devices (illustrated as servers 44), and a storage device 46. By way of example, server system 40 may be a single server or may be a conglomeration of servers that process and preserve high volumes of information.

Clients 50 and 60 are connected to server system via network 70, and respectively include interfaces 52 and 62 to enable communication. One of the clients, (e.g., client 50) is a television. In accordance with embodiments of the present invention, a discovery process is provided to allow the clients to discover servers, as will be further discussed below.

### Providing a Discovery Protocol

As provided above, embodiments of the present invention relates to discovery protocols. In particular, the present invention relates to systems and methods for providing and utilizing a discovery protocol that allows a computer device and a TV to discover each other on a network.

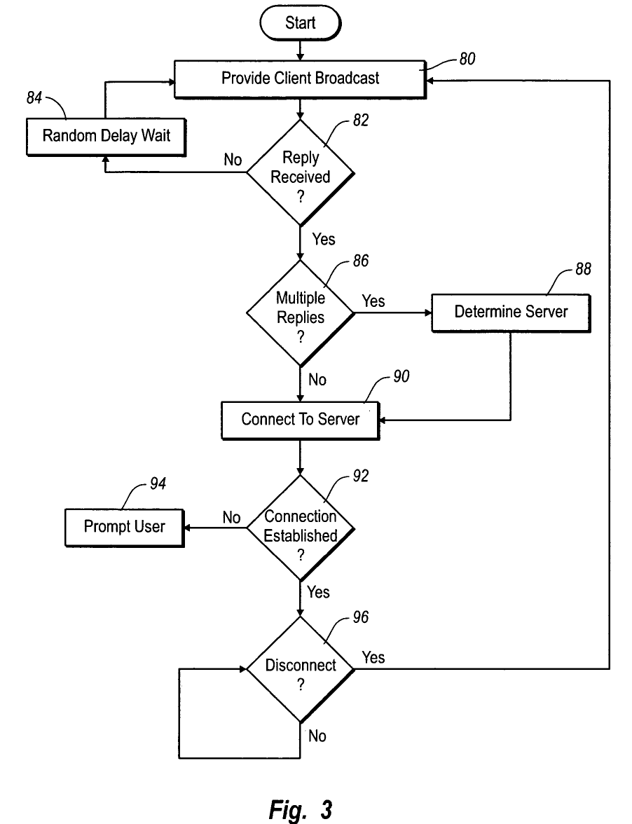

In relation to the embodiment of FIG. 3, the term “client” is being used to refer to a device, such as a TV or other device, and the term “server” is being used to refer a computer device. In FIG. 3, execution begins at step 80 where a client (e.g., TV) broadcasts on the network using a User Datagram Protocol (UDP) a discovery request message to discover the server(s) (e.g., home computer device). While the present embodiment relates to a broadcast, other embodiments of the present invention relate to the utilization of multicasting.

Each server sends a unicast reply using UDP to the client. The reply message includes information about the server IP address and TCP port where client can make a connection. A determination is then made at step 82 as to whether or not a reply as been received. If it is determined that no reply has been received, execution returns back to step 80 to wait for a reply or to submit a subsequent broadcast.

If it is determined at decision block 82 that a reply was not received, execution proceeds to step 84. The client follows a retransmission process for sending a discovery request. The retransmission process uses a randomized exponential backoff strategy which results in the subsequent discovery requests being sent after a random delay time. The delay time between sending subsequent discovery requests is scaled exponentially and then randomized. This helps to reduce the network traffic. The user is given a status indication while the client tries to locate the server.

Each message includes a random identifier (RID), which is same for the request-response transaction. This RID is used to identify a message transaction request-response pair.

A client may receive multiple reply messages (from multiple servers) for its discovery request message. Accordingly, at decision block 86 a determination is made as to whether or not multiple replies have been received. If it is determined at decision block 86 that multiple replies have been received, execution proceeds to step 88 where the client will make a decision to choose a particular server for connection. This determination may be based on the server version. Alternately, the client may choose to connect to the first server from which a reply is obtained. In other embodiments, other strategies are used.

If a server is discovered, the client tries to establish a TCP connection to the server at step 90 using the information obtained from the server in its reply. In some embodiments, the client may try to make connection to multiple servers. A determination is made at decision block 92 as to whether or not a connection was established between the client and server. If it is determined that no connection was established, execution proceeds to step 94. Thus, for example, the user is prompted to start the server (Home PC) if no connection is made after retrying.

The client and server are both capable of handling a network disconnect. At decision block 96 a determination is made as to whether or not a network disconnection has occurred. If it is determined at decision block 96 that a disconnection has not occurred, the system continues to monitor for any disconnection. When a disconnection occurs, execution returns back to step 80, where a client broadcast is performed. In alternate embodiments, after a disconnection occurs, the client may try to re-connect to the server using previously obtained information. In such alternate embodiments, execution returns back to step 90.

Thus, as discussed herein, the embodiments of the present invention relate to discovery protocols. In particular, the present invention relates to systems and methods for providing and utilizing a discovery protocol that allows a computer device and a TV to discover each other on a network.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. In a networked system that includes a client and a server, a method for discovering particular information on the networked system, the method comprising:
initiating a request at the client to discover the particular information, wherein the request is made using at least one of:
(i) a broadcast procedure; and
(ii) a multicast procedure;
receiving a response to the request from a server after a random delay time; and
establishing a connection with the server.

2. A method as recited in claim 1, wherein the request is further made using a randomized exponential backoff strategy.

3. A method as recited in claim 2, wherein the request identifies a particular part of a server where the particular information may be located.

4. A method as recited in claim 2, wherein the client is a television that is configured to provide programming content.

5. A method as recited in claim 4, wherein the client is a television and the server is a computer device.

6. A method as recited in claim 2, further comprising a step for receiving a second response to the request from a second server after the random delay time.

7. A method as recited in claim 6, wherein the step for establishing a connection further comprises a step for determining not to connect to the second sever.

8. A method as recited in claim 7, wherein the step for determining not to connect to the second server is based on at least one of:
(i) whether the client has established a connection with another server; and
(ii) a characteristic of the server which the client establishes a connection.

9. A method as recited in claim 8, wherein the characteristic of the server is a version of the server.

10. A method as recited in claim 2, further comprising:
discovering a network disconnect;
initiating a second request at the client to discover the particular information, wherein the second request is made using at least one of:
(i) a broadcast procedure; and
(iii) a multicast procedure;
receiving a subsequent response to the second request from the server after a random delay time; and
establishing a second connection with the server.

11. A method as recited in claim 10, wherein the request is further made using a randomized exponential backoff strategy.

12. A method as recited in claim 2, wherein the request uses a user datagram protocol.

13. A networked system comprising:
a server coupled to a network; and
a client coupled to the network, wherein the client is configured to selectively provide a request on the network to discover the server, wherein the client is configured to selectively provide programming content to a viewer, and wherein the a request is made at least one of (i) a broadcast procedure and (ii) a multicast procedure.

14. A method as recited in claim 13, wherein the request is further made using a randomized exponential backoff strategy.

15. A networked system as recited in claim 14, wherein the network is a home network.

16. A networked system as recited in claim 14, wherein the request identifies a particular part of the server where desirable information is located.

17. A networked system as recited in claim 14, wherein the client is a television.

18. A networked system as recited in claim 17, wherein the client is a TV and the server is a computer device.

19. A networked system as recited in claim 14, wherein the request uses a user datagram protocol.

20. A computer program product for implementing within a computer system a method for discovering particular information on the networked system, the computer program product comprising:
a computer readable medium for providing computer program code means utilized to implement the method, wherein the computer program code means is comprised of executable code for implementing the steps for:
initiating a request at the client to discover the particular information, wherein the request is made using at least one of:
(i) a broadcast procedure; and
(ii) a multicast procedure;
receiving a response to the request from a server after a random delay time; and
establishing a connection with the server.

21. A computer program product as recited in claim 20, wherein the request is further made using a randomized exponential backoff strategy.

22. A computer program product as recited in claim 21, wherein the client is a television that is configured to provide programming content.

23. A computer program product as recited in claim 21, wherein the client is a television and the server is a computer device.

24. A computer program product as recited in claim 21, wherein the computer program code means is further comprised of executable code for implementing a step for receiving a second response to the request from a second server after the random delay time.

25. A computer program product as recited in claim 24, wherein the step for establishing a connection further comprises a step for determining not to establish a connection to the second sever.

26. A computer program product as recited in claim 25, wherein the step for determining not to establish a connection to the second server is based on at least one of:
(i) whether the client has established a connection with another server; and
(ii) a characteristic of the server with which the client establishes a connection.

27. A method as recited in claim 26, wherein the characteristic of the server is a version of the server.

28. A computer program product as recited in claim 21, wherein the computer program code means is further comprised of executable code for implementing:
discovering a network disconnect;
initiating a second request at the client to discover the particular information, wherein the second request is made using at least one of:
(i) a broadcast procedure; and
(ii) a multicast procedure;
receiving a subsequent response to the second request from the server after a random delay time; and
establishing a second connection with the server.

29. A method as recited in claim 28, wherein the request is further made using a randomized exponential backoff strategy.
